(19) United States
(12) Patent Application Publication
(10) Pub. No.: US 2020/0074221 A1
(43) Pub. Date: Mar. 5, 2020

(54) AUTOMATIC METHOD FOR STRUCTURAL MODAL ESTIMATION BY CLUSTERING

(71) Applicant: Dalian University of Technology, Dalian, Liaoning (CN)

(72) Inventors: Tinghua YI, Dalian, Liaoning (CN); Xiaomei YANG, Dalian, Liaoning (CN); Chunxu QU, Dalian, Liaoning (CN); Hongnan LI, Dalian, Liaoning (CN)

(21) Appl. No.: 16/342,948

(22) PCT Filed: Mar. 28, 2018
(86) PCT No.: PCT/CN2018/080922

§ 371 Date: Apr. 17, 2019

(30) Foreign Application Priority Data
Feb. 26, 2018 (CN) 2018101597107

(51) Int. Cl. G06K 9/62; G01M 5/00; G06F 17/16; G06F 17/50

(52) U.S. Cl. CPC G06K 9/6219; G06F 17/5009; G06F 17/16; G01M 5/00

(57) ABSTRACT

Structural health monitoring relating to an automatic method for estimating structural modal parameters by clustering. The structural modal parameters from state-space models are calculated in different orders by Natural Excitation Technique in combination with Eigensystem Realization Algorithm According to the characteristics that physical modes are those with high similarity and stably appearing at different orders while spurious modes are those with little similarity and unstably appearing at different orders, the modal dissimilarity between two nearest modes in consecutive order are considered as feature of the mode in the lower order. Then, features of modes are used in fuzzy C-means clustering to adaptively acquire the stable cluster where modes are with high similarity. Finally, Hierarchical clustering is used to group the stable modes with identical modal parameters together and thus each physical mode can be obtained.

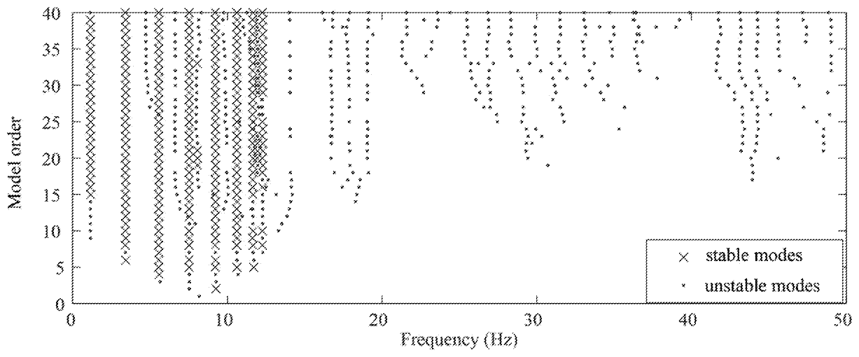

### TECHNICAL FIELD

The presented invention belongs to the field of structural health monitoring, and relates to an automatic method for extracting modal parameters of engineering structures.

### BACKGROUND

Since the health status of engineering structures can be reflected by the variations of modal parameters, estimating modal parameters in a real time is vital to understand the service performance of the structure well. In the previous researches, parametric identification methods, such as Poly-reference Least Squares Complex Frequency domain method, Stochastic Subspace Identification and Eigensystem Realization Algorithm, are more popular due to their clear physical meanings. However, most of these methods should be conducted by the subjective experience when they are applied in the practical engineering. For instance, when Eigensystem Realization Algorithm is used, the order of state-space model is difficult to be determined due to the existence of environmental noise. Generally, some modes will be missed if the model order is under-estimated while the spurious modes will be calculated out if the model order is over-estimated. A widely-used technique to overcome this difficulty and extract the structural physical modes accurately is the stabilization diagram, in which the horizontal coordinate-axis X is the frequency while the vertical coordinate-axis Y means the model order. Since physical modes with identical structural characteristics in different model orders should be consistent in terms of frequencies, mode-shapes and dampings while spurious modes will be scattered, the tolerances of modal parameter differences can be set to determine whether a mode is stable or not. If the modes in the consecutive order with their modal parameter differences are below the tolerances, they are considered as stable modes. Furthermore, if stable modes with same modal parameters appear in various orders, they are more likely to be physical modes. However, the tolerances of modal parameter differences should be tuned manually according to user-experiences. Additionally, the selection of physical modes from stable modes requires manual analysis, which is of great workload and subjectivity for large-scale structures subjected to the complicated ambient excitation.

In recent years, the clustering techniques have been widely used to reduce the influence of subjective experience on the selection of physical modes from the stabilization diagram. However, most of the current researches used the clustering algorithms to automatically extract physical modes from stable modes that have been determined by fixing the tolerance limits of modal parameter differences in the stabilization diagram. These tolerance limits in the stabilization diagram should be determined by the professionals according to the characteristics of practical engineering structures, the environmental noise and the stability of the modal identification methods. Thus it is of great engineering significance to adaptively distinguish between stable and unstable modes without setting tolerance limits in the stabilization diagram.

### SUMMARY

The objective of the presented invention is to provide an automated modal extraction method, which can solve the problems caused by the manual participation, i.e., the identification results are strong subjective and the permanent modal monitoring is difficult.

An automated extraction method for the structural physical modes is proposed. Firstly, Natural Excitation Technique combined with Eigensystem Realization Algorithm is applied to calculate modes from the structural random responses with different model orders. For each mode in the specified order, its nearest mode in the next higher order is found and their dissimilarity (the frequency difference, the damping difference and the mode-shapes difference) is assigned as its features in the clustering process. According to the characteristics that physical modes are stable and similar with their nearest modes in the next high order while spurious modes are unstable and dissimilar with their nearest modes in the next high order, the fuzzy C-means process is used to classify the features of each mode into the stable cluster with high similarity and the unstable cluster with little similarity. Finally, the Hierarchical clustering process is performed on the stable modes, where the stable modes with identical modal parameters but appearing in different orders are grouped together to extract physical modes automatically.

The technical solution of the present invention is as follows:

The procedures of the automated operational modal extraction are as follows:

Step 1: Extraction of Modes with Different Orders

(1) Natural Excitation Technique is used to transform the structural random responses Y(t)=[y(t),y(t+1), . . . , y (t+N)] into the correlation functions r(τ) with different time delays τ, where y(t)=[y₁(t), y₂(t), . . . , y_{z}(t)]^{T}; N is the number of samples; z is the number of sensors.

(2) The correlation functions r(τ) are used to construct the Hankel matrix Hₘₛ(k−1) and Hₘₛ(k) as:

$${H}_{ms} ( k - 1 ) = ( \begin{matrix}r ( k ) & r ( k + 1 ) & … & r ( k + s - 1 ) \\ r ( k + 1 ) & r ( k + 2 ) & … & r ( k + s ) \\ … & … & … & … \\ r ( k + m - 1 ) & r ( k + m ) & … & r ( m + s + k - 2 )\end{matrix} ) \qquad ( 1 )$$

(3) Set k=1, and then the matrix Hₘₛ(k−1) is decomposed by singular value decomposition:

Hₘₛ(0)=USV^{T} (2)

where U and V are unitary matrices; S is the singular value matrix.

(4) Set the order j from 2 to 2nᵤ with the order increment of 2. The singular value matrix S is truncated to obtain the new singular value matrix Sₙ where only the first j non-zero singular values of S are remained, repeating nᵤ times. Then Eigensystem Realization Algorithm is used to calculate the modal parameters in different model orders, where the frequency fᵢⱼ, damping ratio ξᵢⱼ, mode shapes φᵢⱼ and modal observability vectors vᵢⱼ, i=1,2, . . . , j and j=2, 4, . . . , 2nᵤ, respectively.

(5) For mode i in the j order, its nearest mode p in the j+2 order can be found by minimizing the sum of the frequency differences and the modal observability vector dissimilarity between mode i in the j order and all modes in the j+2 order. In this case, the frequency difference d f_{ij,p(j+2}=|fᵢⱼ−fₚ₍ⱼ₊₁₎|/max(fᵢⱼfₚ₍ⱼ₊₂₎), the damping difference dξ_{ij,p(j+2)}=|ξᵢⱼ−ξₚ₍ⱼ₊₂₎|/max(ξᵢⱼ, ξₚ₍ⱼ₋₂₎) and the modal observability vector similarity MOC_{ij,p(j+2})=(vᵢⱼ*vₚ₍ⱼ₊₂₎)/((vᵢⱼ*vᵢⱼ)(vₚ₍ⱼ₊₂₎*vᵢₚ₍ⱼ₊₂₎)) of mode i in the j order are calculated respectively. In addition, Δ_{ij,p(j+2)}=df_{ij,p(j+2)}+dMOC_{ij,p(j+2)} is defined as the nearest distance of mode i in the j order.

Step 2: Separation of Stable Modes and Unstable Modes.

(6) The Box-Cox method is used to transform the frequency difference sequence df, the damping difference sequence dξ and the modal observability vector dissimilarity sequence 1−MOC, which are obtained from step (5). And then normalize the transformed sequences into the standard normalized sequences df^{s}, dξ^{s} and 1−MOC^{s}.

(7) The modal dissimilarity q_{ij,p(j+2)}=[df_{ij,p(j+2)}^{s}dξ_{ij,p(j+2)}^{s}1−MOC_{ij,p(j+2)}^{s}]^{T} is set as the feature of mode i in the j order. Then the fuzzy C-means clustering is used to divide these features into stable cluster C₁ or unstable cluster C₂ by minimizing the objective function:

$$\{ {C}_{k} , {η}_{k} \} = {arg min}_{C} {\sum }_{k = 1}^{2} {\sum }_{{q}_{ij , p ( j + 2 )} ∈ {G}_{k}} {η}_{ij , k}^{b} {‖ ( {q}_{ij , p ( j + 2 )} - {μ}_{k} ) ‖}^{2} ( k = 1 , 2 ) \qquad ( 3 )$$

where k is the clustering number; b represents fuzziness factor (b=2); ηₖ represents the membership degree matrix in which the component η_{ij,k} means the membership of mode i in the j order that belongs to cluster k:

$${η}_{ij , k} = {[ {\sum }_{t = 1}^{2} {( \frac{‖ ( {q}_{ij , p ( j + 2 )} - {μ}_{k} ) ‖}{‖ ( {q}_{ij , p ( j + 2 )} - {μ}_{t} ) ‖} )}^{\frac{2}{b - 1}} ]}^{- 1} \qquad ( 4 )$$

where the cluster center:

$${μ}_{k} = \frac{{\sum }_{j = 2}^{2 {n}_{u}} {\sum }_{i = 1}^{j} {η}_{ij , k}^{b} {q}_{ij , p ( j + 2 )}}{{\sum }_{j = 1}^{{n}_{u}} {\sum }_{i = 1}^{2 j} {η}_{ij , k}^{b}} \qquad ( 5 )$$

Step 3: Estimation of Physical Modes from Stable Modes

(8) The Hierarchical clustering method is used to classify the stable modes in the cluster C₁ into physical modes, where the detailed steps are as follows:
1) Set each stable mode to be its cluster.
2) Group the two clusters with the minimum distance into one cluster.
3) Repeat step 2) until the minimum distance between each cluster exceeds the tolerance limit Δₗᵢₘ.
4) Choose the clusters with their sizes (the number of modes in the cluster) outnumber the threshold η_{T} as the physical clusters.

In step 2), the distance between mode i in the g order and mode h in the l cluster is calculated as:

Δ_{ig,hl}=df_{ig,hl}+1−MOC_{ig,hl} (6)

Meanwhile, the distance between each cluster is obtained as:

$${Δ}_{g , l} = \frac{1}{{n}_{g} {n}_{l}} {\sum }_{i = 1}^{{n}_{g}} {\sum }_{h = 1}^{{n}_{l}} {Δ}_{ig , hl} \qquad ( 7 )$$

where n_{g} and nₗ are the number of modes in the current clusters g and l, respectively.

The tolerance Δₗᵢₘ is defined according to the 95% confidence level of the nearest distance distribution corresponding to all stable modes determined by step (5), p(Δ≤Δₗᵢₘ)=95%. The threshold n_{T}=(0.3˜0.5)nᵤ.

(9) For each physical cluster, the mode with its frequency closest to the average of frequencies of all modes in this cluster is deemed as the identification results.

The advantage of the invention is that stable modes and unstable modes can be adaptively divided by clustering the modal dissimilarity rather than modal parameter. This process can identify modal parameters automatically since the artificially threshold is not required.

### DESCRIPTION OF DRAWINGS

The sole FIGURE presents the distribution of stable modes and unstable modes.

### DETAILED DESCRIPTION

The present invention is further described below in combination with the technical solution.

The numerical example of 8 degree-of-freedom in-plane lumped-mass model is employed. The mass for each floor and stiffness for each story are 1.00×10⁶ kg and 1541.07×10⁶ N/m, respectively. The Rayleigh damping ratios are set as αM+βK where the coefficients are α=0.30 and β=0.50×10⁻³. The model is excited by a zero-mean Gaussian white noise and the stochastic acceleration response is contaminated by the measurement noise where the ratio of measurement noise variance to signal variance is 20%. The sampling frequency is 100 Hz. The procedures are described as follows:

(1) The structural random responses Y(t)=[y(t),y(t+1), . . . , y (t+N)] are transformed into the correlation functions r(τ)=[r₁₁(τ) r₂₁(τ) . . . r₈₁(τ)]^{T} by

Natural Excitation Technique, where the measurement channel 1 is select as the reference channel.

(2) Set m=80, s=160. The correlation functions r (τ) with τ=1˜239 and τ=2˜240 are used to build Hankel matrices Hₘₛ(0) and Hₘₛ(1), respectively.

(3) Decompose the Hankel matrix Hₘₛ(0) by the singular value decomposition where the dimension of the singular value matrix S is 640×160.

(4) Set the order j=2 and truncate the matrix S to obtain the new singular value matrix Sₙ with the dimension of 2×2. Then frequency fᵢⱼ, damping ξᵢⱼ, mode-shapes φᵢⱼ and modal observability vector vᵢⱼ are obtained by Eigensystem Realization Algorithm, respectively. Ranging the order from j=j+2 to j=2nᵤ (nᵤ=40), modes in different orders are calculated.

(5) For mode i in the j order, its nearest mode p in the j+2 order can be found by minimizing the sum of the frequency differences and the modal observability vector dissimilarity between mode i in the j order and all modes in the j+2 order. In this case, the frequency difference df_{ij,p(j+2)}=|fᵢⱼ−fₚ₍ⱼ₊₂₎|/max(fᵢⱼ, fₚ₍ⱼ₊₂₎), the damping difference dξ_{ij,p(j+2)}=|ξᵢⱼ−ξₚ₍ⱼ₊₂₎|/max(ξᵢⱼ, ξₚ₍ⱼ₊₂₎) and the modal observability vector similarity MOC_{ij,p(j+2)}=(vᵢⱼ*vₚ₍ⱼ₊₂₎)/((vᵢⱼ*vᵢⱼ)(vₚ₍ⱼ₊₂₎*vᵢₚ₍ⱼ₊₂₎)) of mode i in the j+2 order are calculated respectively. In addition, Δ_{ij,p(j+2)}=df_{ij,p(j+2)}+dMOC_{ij,p(j+2)} is defined as the nearest-distance of mode i in the j+2 order.

(6) The Box-Cox method is used to transform the frequency difference sequence df, the damping difference sequence dξ and the modal observability vector dissimilarity sequence 1−MOC, which are obtained from step (5). And then normalize the transformed sequences into the standard normalized sequences d f^{s}, dξ^{s} and 1−MOC^{s}.

(7) The modal dissimilarity q_{ij,p(j+2)}=[df_{ij,p(j+2)}^{s} dξ_{ij,p(j+2)} 1−MOC_{ij,p(j+2)}]^{T} is set as the feature of mode i in the j order. Then the fuzzy C-means clustering is used to extract the stable cluster C₁. The frequencies corresponding to the stable cluster C₁ are shown in the FIGURE. Then the tolerance limit Δₗᵢₘ=0.154% is given automatically according to the nearest distance distribution p(Δ≤Δₗᵢₘ)=95% of stable modes in cluster C₁.

(8) The stable modes in the cluster C₁ are classified by Hierarchical clustering method according to the Eqs.(6) and (7). The threshold n_{T} is set as 0.5nᵤ. Thus eight physical clusters are obtained. The mode in each physical cluster with its frequency closest to the mean frequency of modes in this cluster is deemed as the identification result. The frequencies and damping ratios of identified modes are f₁=1.153 Hz, f₂=3.419 Hz, f₃=5.570 Hz, f₄=7.536 Hz, f₅=9.234 Hz, f₆=10.624 Hz, f₇=11.652 Hz, f₂=12.282 Hz; ξ₁=2.219%, ξ₂=1.254%, ξ₃=1.291%, ξ₄=1.459%, ξ₅=1.695%, ξ₆=1.903%, ξ₇=2.059%, ξ₈=2.152%.

We claim

1. An automatic method for structural modal estimation by clustering, wherein:
step 1: extraction of modes with different orders
(1) Natural Excitation Technique is used to transform structural random responses Y(t)=[y(t),y(t+1), . . . , y(t+N)] into correlation functions r(τ) with different time delays τ, where y(t)=[y₁(t), y₂(t), . . , y_{z}(t)]^{T}; N is a number of samples; z is a number of sensors;
(2) the correlation functions r(τ) are used to construct the Hankel matrix Hₘₛ(k−1) and Hₘₛ(k) as:
$${H}_{ms} ( k - 1 ) = ( \begin{matrix}r ( k ) & r ( k + 1 ) & … & r ( k + s - 1 ) \\ r ( k + 1 ) & r ( k + 2 ) & … & r ( k + s ) \\ … & … & … & … \\ r ( k + m - 1 ) & r ( k + m ) & … & r ( m + s + k - 2 )\end{matrix} ) \qquad ( 1 )$$
(3) set k=1, and then the matrix Hₘₛ(k−1) is decomposed by singular value decomposition:
Hₘₛ(0)=USV^{T} (2)
where U and V are unitary matrices; S is the singular value matrix;
(4) set the order j from 2 to 2nᵤ with the order increment of 2; the singular value matrix S is truncated to obtain the new singular value matrix Sₙ where only the first j non-zero singular values of S are remained, repeating nᵤ times; then Eigensystem Realization Algorithm is used to calculate the modal parameters in different model orders, where the frequency fᵢⱼ, damping ratio ξᵢⱼ, mode shapes φᵢⱼ and modal observability vectors vᵢⱼ, i=1,2, . . . , j and j=2, 4, . . . , 2nᵤ, respectively;
(5) for mode i in the j order, its nearest mode p in the j+2 order can be found by minimizing the sum of the frequency differences and the modal observability vector dissimilarity between mode i in the j order and all modes in the j+2 order; in this case, the frequency difference d f_{ij,p(j+2)}=|fᵢⱼ−fₚ₍ⱼ₊₂₎|/max(fᵢⱼ, fₚ₍ⱼ₊₂₎), the damping difference dξ_{ij,p(j+2)}=|ξᵢⱼ−ξₚ₍ⱼ₊₂₎|/max(ξᵢⱼ, ξₚ₍ⱼ₊₁₎) and the modal observability vector similarity MOC_{ij,p(j+2)}=(vᵢⱼ*vₚ₍ⱼ₊₂₎)/((vᵢⱼ*vᵢⱼ)(vₚ₍ⱼ₊₂₎*vᵢₚ₍ⱼ₊₂₎)) of mode i in the j order are calculated respectively; in addition, Δ_{ij,p(j+2)}=df_{ij,p(j+2)}+dMOC_{ij,p(j+2)} is defined as the nearest distance of mode i in the j order;
step 2: separation of stable modes and unstable modes;
(6) Box-Cox method is used to transform the frequency difference sequence df, the damping difference sequence dξ and the modal observability vector dissimilarity sequence 1−MOC, which are obtained from step (5); and then normalize the transformed sequences into the standard normalized sequences d f^{s}, dξ^{s} and 1−MOC^{s};
(7) the modal dissimilarity q_{ij,p(j+2)}=[df_{ij,p(j+2)}^{s} dξ_{ij,p(j+2)} 1−MOC_{ij,p(j+2)}^{s}]^{T} is set as the feature of mode i in the j order; then the fuzzy C-means clustering is used to divide these features into stable cluster C₁ or unstable cluster C₂ by minimizing the objective function:
$$\{ {C}_{k} , {η}_{k} \} = {arg min}_{C} {\sum }_{k = 1}^{2} {\sum }_{{q}_{ij , p ( j + 2 )} ∈ {G}_{k}} {η}_{ij , k}^{b} {‖ ( {q}_{ij , p ( j + 2 )} - {μ}_{k} ) ‖}^{2} ( k = 1 , 2 ) \qquad ( 3 )$$
where k is the clustering number; b represents fuzziness factor (b=2); ηₖ represents the membership degree matrix in which the component η_{ij,k} means the membership of mode i in the j order that belongs to cluster k:
$${η}_{ij , k} = {[ {\sum }_{t = 1}^{2} {( \frac{‖ ( {q}_{ij , p ( j + 2 )} - {μ}_{k} ) ‖}{‖ ( {q}_{ij , p ( j + 2 )} - {μ}_{t} ) ‖} )}^{\frac{2}{b - 1}} ]}^{- 1} \qquad ( 4 )$$
where the cluster center:
$${μ}_{k} = \frac{{\sum }_{j = 2}^{2 {n}_{u}} {\sum }_{i = 1}^{j} {η}_{ij , k}^{b} {q}_{ij , p ( j + 2 )}}{{\sum }_{j = 1}^{{n}_{u}} {\sum }_{i = 1}^{2 j} {η}_{ij , k}^{b}} \qquad ( 5 )$$
step 3: estimation of physical modes from stable modes
(8) hierarchical clustering method is used to classify the stable modes in the cluster C₁ into physical modes, where the detailed steps are as follows:
5) set each stable mode to be its cluster;
6) group the two clusters with the minimum distance into one cluster;
7) repeat step 2) until the minimum distance between each cluster exceeds the tolerance limit Δₗᵢₘ;
8) choose the clusters with their sizes (the number of modes in the cluster) outnumber the threshold n_{T} as the physical clusters;
in step 2), the distance between mode i in the g order and mode h in the l cluster is calculated as:
Δ_{ig,hl}=df_{ig,hl}+1−MOC_{ig,hl} (6)
meanwhile, the distance between each cluster is obtained as:
$${Δ}_{g , l} = \frac{1}{{n}_{g} {n}_{l}} {\sum }_{i = 1}^{{n}_{g}} {\sum }_{h = 1}^{{n}_{l}} {Δ}_{ig , hl} \qquad ( 7 )$$
where n_{g} and nₗ are the number of modes in the current clusters g and l, respectively;
the tolerance Δₗᵢₘ is defined according to the 95% confidence level of the nearest distance distribution corresponding to all stable modes determined by step (5), p(Δ≤Δₗᵢₘ)=95%; the threshold n_{T}=(0.3˜0.5)nᵤ;
(9) for each physical cluster, the mode with its frequency closest to the average of frequencies of all modes in this cluster is deemed as the identification results.
